(19) United States
(12) Patent Application Publication
(10) Pub. No.: US 2026/0301315 A1
(43) Pub. Date: Oct. 1, 2026

(54) POINT CLOUD MANAGEMENT SYSTEM AND METHODS

(71) Applicant: Telefonaktiebolaget LM Ericsson (publ), Stockholm (SE)

(72) Inventors: Volodya GRANCHAROV, Solna (SE); Sigurdur SVERRISSON, Kungsängen (SE); Elijs DIMA, Upplands Väsby (SE); Vladislav POLIANSKII, Stockholm (SE)

(73) Assignee: Telefonaktiebolaget LM Ericsson (publ), Stockholm (SE)

(21) Appl. No.: 19/489,353

(22) PCT Filed: Jun. 8, 2023
(86) PCT No.: PCT/EP2023/065337

§ 371 Date: Dec. 2, 2025

(51) Int. Cl. G06T 17/00; G06V 10/25

(52) U.S. Cl. CPC G06T 17/00; G06V 10/25; G06V 2201/07

(57) ABSTRACT

A method for providing one or more PCs to a user. The method includes obtaining a set of images of a region of interest (ROI) and obtaining a set of base PCs associated with the ROI, wherein the set of base PCs comprises a first base PC and a second base PC. The method also includes receiving, from the user, a request for a PC related to the ROI. The method also includes, after receiving the request, selecting base PCs from the set of base PCs; generating the PC using the selected base PCs; and providing the generated PC to the user. The base PCs selected from the set of base PCs includes the first base PC and the second base PC, the first base PC includes points not included in the second base PC, the second base PC includes points not included in the first base PC, and the generated PC comprises: i) each point included in the first base PC and ii) each point included in the second base PC that is not also included in the first base PC.

### TECHNICAL FIELD

Disclosed are embodiments related to methods and systems for managing (e.g., storing, generating) point clouds.

### BACKGROUND

An unmanned aerial vehicle (UAV) (a.k.a., “drone”) equipped with one or more sensors (e.g., a red-green-blue (RGB) camera, and RGB depth (RGBD) camera, LiDAR, etc.) can be used to obtain images of an area of interest that contains an object of interest (OOI) (e.g., a telecommunications cell tower or other OOI) and these images can then be used to generate a three-dimensional (3D) model of the area, including the OOI. For instance, the drone typically orbits the OOI with a camera pointing down at 45° and the camera is used to obtain many images of the OOI from many different angles. These images are then used to form a three-dimensional (3D) point cloud (or simply “point cloud” for short), which is a set of points where each point has a unique location in a 3D space, which location may be defined by 3 values: x, y, z (hence the points that comprise a point cloud are sometimes referred to as 3D points). The most popular approach for generating such a point cloud is to use Structure from Motion (SfM) technology (e.g., SfM technology from Pix4D (www.pix4d.com), COLMAP (see colmap.github.io/), etc.).

The generated point cloud of the OOI is sometimes referred to as a digital twin of the OOI. Digital twins are becoming an essential component in many industrial applications. As noted above, the process of creating the point cloud of a physical environment consists of the steps of data acquisition and 3D reconstruction. Data acquisition is typically performed with visual cameras and/or LiDARs. In the case of modeling of large outdoor structures, like radio towers used in telecommunications or transmission tower used in power grid, etc., the drone orbits the object of interest and collects many high-resolution images at different positions on the orbit. This set of two-dimensional (2D) images are processed for cloud-based 3D Reconstruction that recover 3D geometry and dimensions of the physical environment.

These steps result in a point cloud, which can be used to visually inspect and perform measurement of the 3D scene, or generate CAD/BIM model of the OOI, etc. Out of the millions or hundreds of millions of points within a point cloud, only those points lying on the surface of the OOI, or its very close surroundings, are relevant to certain users. That is, for example, points corresponding to a background object (e.g., the ground, the sky, etc.) may negatively affect user experience and quality of resulting CAD/BIM model. Further, the size of a typical point cloud is of the order of GBs, so a large number unwanted points place a stress on storage and transmission operations. Therefore, point cloud truncation that filters out unnecessary points is an important step in many scenarios.

An alternative to point cloud truncation is to impose controls on the data acquisition step, such as, for example, restricting camera angle, as suggested by a web page hosted at Pix4d.com (see support(dot)pix4d(dot)com/hc/en-us/articles/310441078692-How-to-scan-cell-towers-PIX4Dscan). A problem with this approach is that it works only in special cases (i.e., particular type of scanned object and particular type of orbit). In the general case, the camera always captures unwanted part of the background.

World Intellectual Property (WIPO) published patent applications WO2022/073614 and WO2022/048741 describe techniques for point cloud truncation with respect to an OOI.

### SUMMARY

Certain challenges presently exist. For instance, it is conventional for point clouds to be stored in a point cloud management system (PCMS) and then accessed via a network (e.g., the internet) by technicians with different user roles for different purposes and applications. This, however, can create inconvenience for technicians that need to work with only a particular portion of a stored point cloud (PC). Moreover, due to the large size of a typical PC (e.g., multiple Gigabytes) the cost for transmission can be significant when the technicians is not at the location where the PC is stored as a large volume of data needs to be sent over the network, which is costly in both bandwidth and time.

Accordingly, in one aspect there is provided a method for providing one or more PCs to a user. The method includes obtaining a set of images of a region of interest (ROI) and obtaining a set of base PCs associated with the ROI, wherein the set of base PCs comprises a first base PC and a second base PC. The method also includes receiving, from the user, a request for a PC related to the ROI. The method also includes, after receiving the request, selecting base PCs from the set of base PCs; generating the PC using the selected base PCs; and providing the generated PC to the user. The base PCs selected from the set of base PCs includes the first base PC and the second base PC, the first base PC includes points not included in the second base PC, the second base PC includes points not included in the first base PC, and the generated PC comprises: i) each point included in the first base PC and ii) each point included in the second base PC that is not also included in the first base PC.

In another aspect there is provided a computer program comprising instructions which when executed by processing circuitry of a PCMS causes the PCMS to perform any of the methods disclosed herein. In one embodiment, there is provided a carrier containing the computer program wherein the carrier is one of an electronic signal, an optical signal, a radio signal, and a computer readable storage medium. In another aspect there is provided a PCMS that is configured to perform the methods disclosed herein. The PCMS may include memory and processing circuitry coupled to the memory.

An advantage of the embodiments disclosed herein is that they reduce the amount of PC data that is transmitted from the portal server to the user requesting the data without increasing the server storage cost.

### BRIEF DESCRIPTION OF THE DRAWINGS

The accompanying drawings, which are incorporated herein and form part of the specification, illustrate various embodiments.

FIG. 1A illustrates an example point cloud.

FIG. 1B illustrates an example system.

FIG. 2 illustrates a method of obtaining images of an OOI.

FIG. 3 illustrates a process according to an embodiment.

FIG. 4A illustrates an example base PC.

FIG. 4B illustrates an example base PC.

FIG. 4C illustrates an example base PC.

FIG. 5 illustrates a PCMS dynamically generating PCs based on user input.

FIG. 6 illustrates an example generated PC generated from two base PCs.

FIG. 7 is a flowchart illustrating a process according to some embodiments.

FIG. 8 is a block diagram of PCMS according to some embodiments.

### DETAILED DESCRIPTION

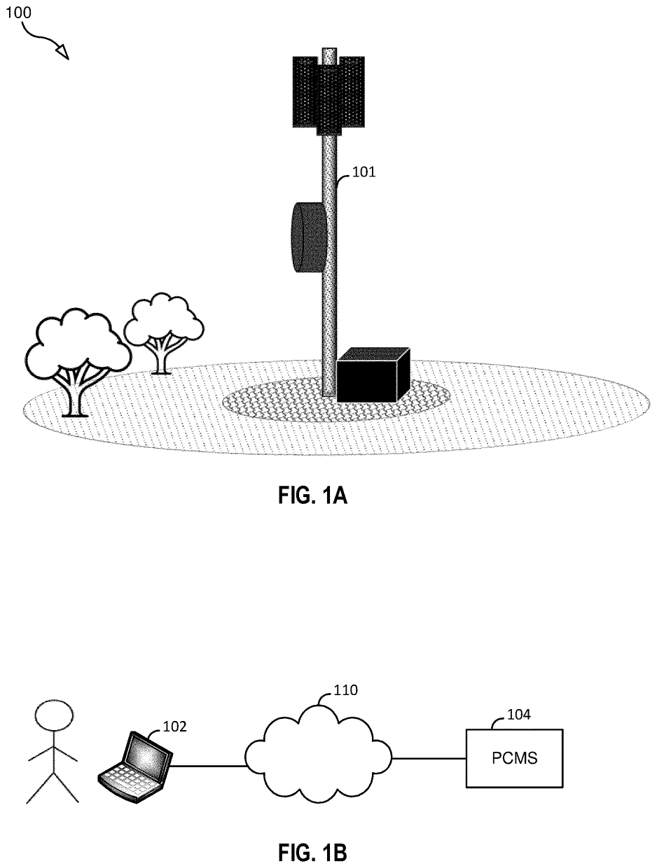

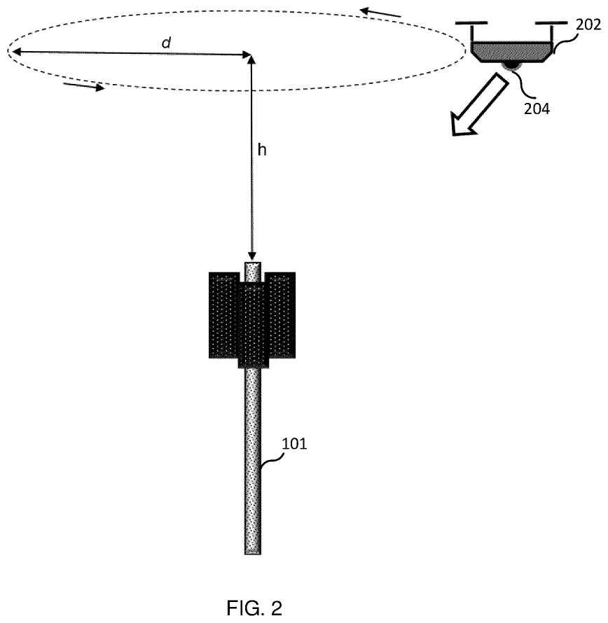

FIG. 1A illustrates an example point cloud (PC) 100 of a regions of interest (ROI) that includes several objects. Conventionally, PC 100 may be stored in a PCMS 104 and transferred in popular formats like LAS, PLY, XYZ, etc to a user's device 102 via a network 110 shown in FIG. 1B. The most popular approach for generating PC 100 is to use Structure from Motion (SfM) technology (e.g., SfM technology from Pix4D (www.pix4d.com), COLMAP (see colmap.github.io/), etc.). These methods use consecutive images, generated according to the process illustrated in FIG. 2. In this example, one OOI in point cloud 100 is a cell tower 101.

As shown in FIG. 2 images of cell tower 101 are collected using a drone 202 equipped with a camera 204. As shown in FIG. 2, drone 202 orbits a cell tower 101, where the orbit has a radius of d (e.g., d is 20 to 40 meters), and at various different points on the orbital path (e.g., 80 to 160 different points on the orbital path) the camera takes an image (thus, generally, 80 to 160 images are obtained). The drone is positioned a distance h from the top of the tower 101 (in some embodiments h=d or h=2d) and the camera 204 points down at 45-60 degrees. Each image taken by the camera 204 captures the entire cell tower 101 from top to bottom. The images are then processed using known techniques to generate PC 100, which is referred to herein as “primary” PC 100.

As noted above, a first user (e.g., technician) may need to work with only a first portion of primary PC 100, a second user may need to work with only a second portion of primary PC 100 (the second portion may encompass the first portion), and a third user may need to work with the entire primary PC 100.

Accordingly, this disclosure proposes an embodiment in which primary PC 100 is partitioned into a set of two or more base PCs, where, in one embodiment, each base PC does not overlap with any other base PC, so the amount of storage needed to store the set of base PCs is the same (or nearly the same) as the amount of storage needed to store primary PC 100. Hence, in one embodiment, after the set of base PCs is stored in PCMS 104 the primary PC 100 can be removed from PCMS 104.

Next, when a user with a particular user role requests a point cloud of an ROI (e.g., PC 100), based on the detected user role (e.g., login ID), the correct base PCs are fused, if needed, to generate the right type of PC for that user. Hence, the embodiments provide for the storage of multiple base PCs of an ROI and the dynamic combination of these base PCs based on, for example, the type of access request.

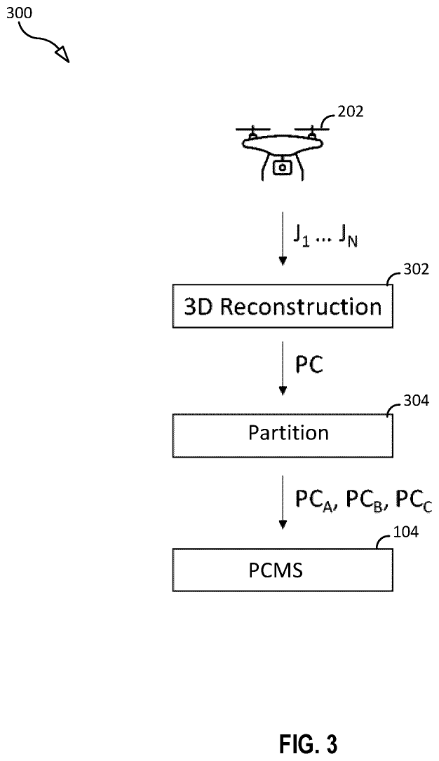

FIG. 3 illustrates a process 300 according to an embodiment. As shown in FIG. 3, drone 202 produces a set of N images J₁ . . . J_{N} by scanning an ROI. These images are used as input to a 3D Reconstruction module 302 that generates the primary PC of the scanned area. 3D Reconstruction task could be performed by solution like COLMAP, Pix4D, etc. The primary PC is analyzed and partitioned into different base PCs (a.k.a., “layers”) by a partition module 304. PC truncation solutions as those described in WO2022/073614 and WO2022/048741 could be used to determine point clouds partitioning.

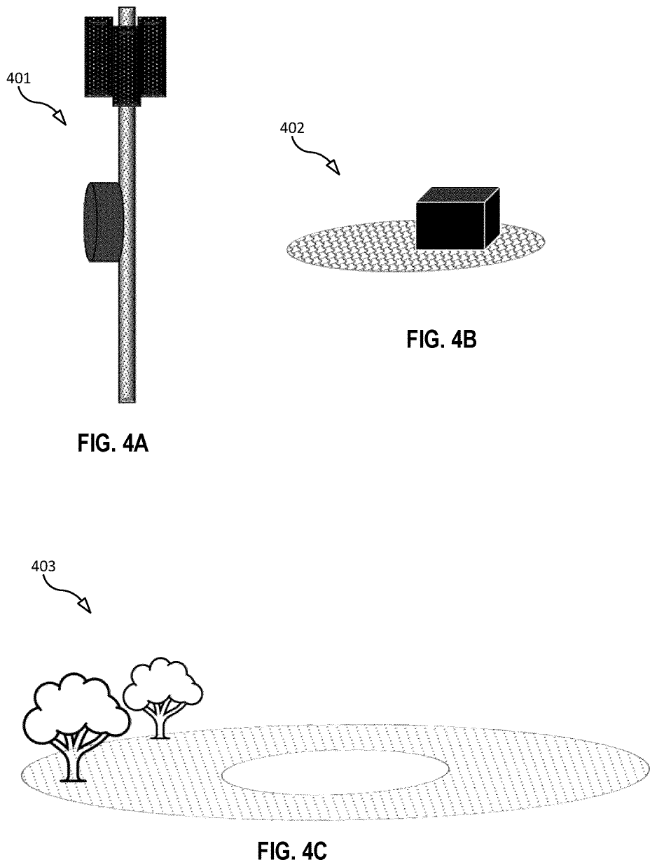

FIGS. 4A, 4B, and 4C illustrate three different example base PCs: base PC 401 (a.k.a., PC_{A}), base PC 402 (a.k.a., PC_{B}), and base PC 403 (a.k.a., PC_{C}) generated from primary PC 100. In the example shown, each base PC is disjoint with respect to each other base PC (i.e., the base PCs do not share any 3D points), but this is not a requirement, and the union of PC_{A}, PC_{B}, and PC_{C} is primary PC 100. Each base PC is stored in PCMS 104 in the same way legacy solutions store the primary PC (e.g., in .las format, .ply format, .e57 format, or other PC format). In one embodiment, primary PC 100 exists just for the time of analysis and partitioning and is not permanently stored in PCMS 104. Instead, the individual base PCs are used to dynamically create PCs to be consumed by technicians with different user roles. This dynamic generation of PCs to be exposed from PCSM 104 is described below.

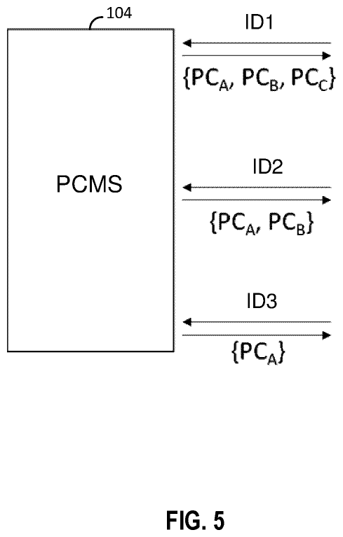

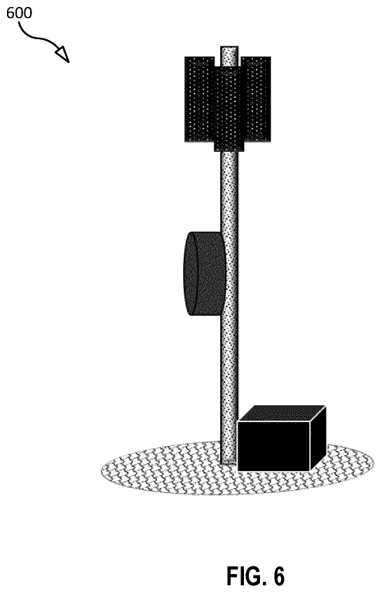

FIG. 5 illustrates PCMS 104 dynamically generating PCs based on user input. For example for a user input from a user with a login ID of ID1, PCMS 104 generates a PC that is the union of PC_{A}, PC_{B}, and PC_{C}; for a user input from a user with a login ID of ID2, PCMS 104 generates a PC that is the union of PC_{A} and PC_{B}; and for a user input from a user with a login ID of ID3, PCMS 104 simply provides PC_{A}. That is, In one embodiment, a request from a user for retrieval of a point cloud from PCMS 104 is analyzed and the user role of the user is determined. The user role is determined based on, for example, the user's login ID. Based on that user role and the specified ROI, a point cloud is dynamically generated from the stored base PCs, and exposed to (e.g., transmitted to) the requesting user. An example PC 600 returned to the user (based on the determined user role) is illustrated in FIG. 6. PC 600 is the union of PC 401 (PC_{A}) and PC 402 (PC_{B}). Because all base PCs are just sets of 3D points in the same coordinate system, generating unions of those sets is very lightweight. As another example, if “Network Design Optimization (NDO) Engineer” user role is detected from the login ID (e.g., ID1) and the specified ROI is the ROI with which primary PC 100 is associated, then the exposed point cloud is just a union of all of the base PCs without any additional point cloud processing. In other words, the exposed PC is just: PC=PC_{A}∪PC_{B}∪PC_{C}.

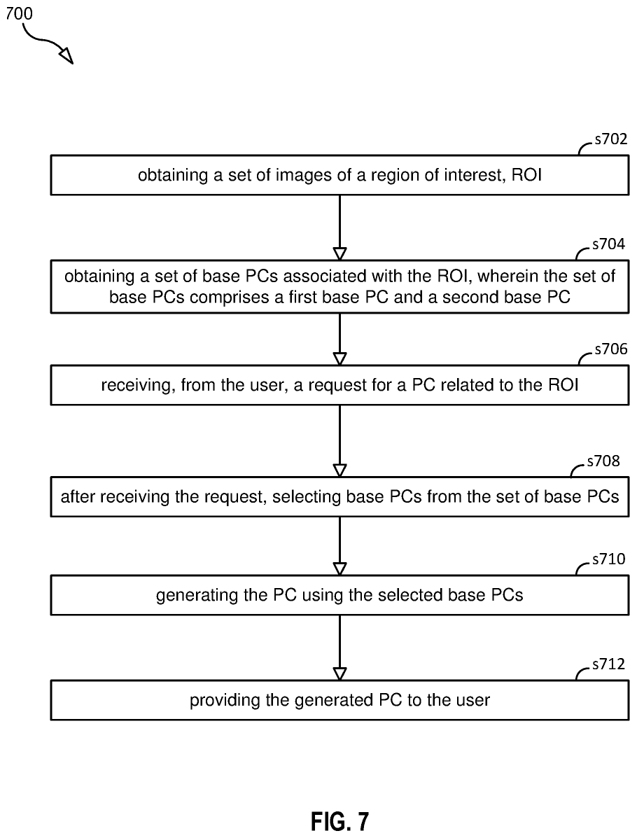

FIG. 7 is a flow chart illustrating a process 700, according to an embodiment, for providing one or more PCs to a user. Process 700 may begin in step s 702.

Step s702 comprises obtaining a set of images of a ROI.

Step s704 comprises obtaining a set of base PCs associated with the ROI, wherein the set of base PCs comprises a first base PC and a second base PC.

Step s706 comprises receiving, from the user, a request for a PC related to the ROI.

Step s708 comprises after receiving the request, selecting base PCs from the set of base PCs.

Step s710 comprises generating the PC using the selected base PCs.

Step s712 comprises providing the generated PC to the user.

The base PCs selected from the set of base PCs includes the first base PC and the second base PC, the first base PC includes points not included in the second base PC, the second base PC includes points not included in the first base PC, and the generated PC comprises: i) each point included in the first base PC and ii) each point included in the second base PC that is not also included in the first base PC.

In some embodiments, obtaining the set of base PCs comprises generating a primary PC and partitioning the primary PC into the set of base PCs. In some embodiments, generating the primary PC comprises generating the primary PC from the obtained set of images (e.g., by means of a three-dimensional reconstruction tool such as COLMAP).

In some embodiments, the obtained set of images comprises N images, where N>1, and partitioning the primary PC into the set of base PCs comprises truncating the primary PC by performing a truncation process that comprises: [1] for each of the N images, obtaining two-dimensional, 2D, point information associated with the image, wherein the 2D point information associated with the image identifies a point on a common plane (e.g., the ground plane); [2] selecting a point cloud truncation method using the obtained 2D point information; and [3] implementing the selected a point cloud truncation method on the point cloud.

In some embodiments, partitioning the primary PC into the set of base PCs comprises: identifying an object of interest, wherein a set of points in the primary PC is associated with the object of interest; determining the set of points in the primary PC that are associated with the object of interest; and forming a base PC using the determined set of points (e.g., the base PC that is formed consists only of the set of points that are associated with the object of interest).

In some embodiments, selecting base PCs from the set of base PCs comprises: determining a role assigned to the user; and selecting the base PCs from the set of base PCs based on the role assigned to the user. In some embodiments, each base PC included in the set of base PCs is associated with a set of one or more roles, the method further comprises storing information that identifies, for each base PC included in the set of base PCs, the roles with which the base PC is associated, and the step of selecting the base PCs from the set of base PCs based on the role assigned to the user comprises selecting only the base PCs that are associated with the role assigned to the user.

In some embodiments, the first base PC includes a first set of points, the second base PC includes a second set of points, and the first set of points and the second set of points are disjoint.

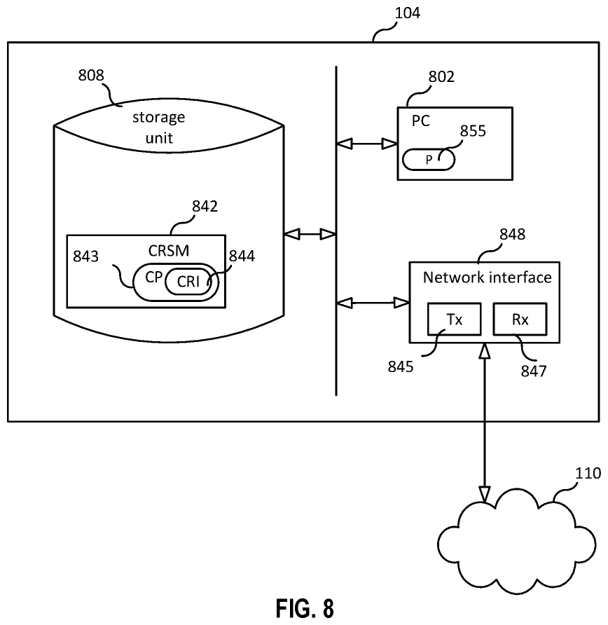

FIG. 8 is a block diagram of PCMS 104, according to some embodiments. As shown in FIG. 8, PCMS 104 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., PCMS 104 may be a distributed computing apparatus or a monolithic computing apparatus); at least one network interface 848 (e.g., a physical interface or air interface) comprising a transmitter (Tx) 845 and a receiver (Rx) 847 for enabling PCMS 104 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling PCMS 104 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes PCMS 104 to perform steps described herein (e.g., steps described herein with reference to the flow charts). In other embodiments, PCMS 104 may be configured to perform steps described herein without the need for code. That is, for example, PC 802 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. And as used herein “a” means “at least one” or “one or more.”

1. A method for providing one or more point clouds (PCs) to a user, the method comprising:
obtaining a set of images of a region of interest (ROI);
obtaining a set of base PCs associated with the ROI, wherein the set of base PCs comprises a first base PC and a second base PC;
receiving, from the user, a request for a PC related to the ROI;
after receiving the request, selecting base PCs from the set of base PCs;
generating the PC using the selected base PCs; and
providing the generated PC to the user, wherein
the base PCs selected from the set of base PCs includes the first base PC and the second base PC,
the first base PC includes points not included in the second base PC,
the second base PC includes points not included in the first base PC, and
the generated PC comprises: i) each point included in the first base PC and ii) each point included in the second base PC that is not also included in the first base PC.

2. The method of claim 1, wherein
obtaining the set of base PCs comprises:
generating a primary PC; and
partitioning the primary PC into the set of base PCs.

3. The method of claim 2, wherein
generating the primary PC comprises generating the primary PC from the obtained set of images.

4. The method of claim 3, wherein
the obtained set of images comprises N images, where N>1, and
partitioning the primary PC into the set of base PCs comprises truncating the primary PC by performing a truncation process that comprises:
for each of the N images, obtaining two-dimensional, 2D, point information associated with the image, wherein the 2D point information associated with the image identifies a point on a common plane;
selecting a point cloud truncation method using the obtained 2D point information; and
implementing the selected a point cloud truncation method on the point cloud.

5. The method of claim 2, wherein
partitioning the primary PC into the set of base PCs comprises:
identifying an object of interest, wherein a set of points in the primary PC is associated with the object of interest;
determining the set of points in the primary PC that are associated with the object of interest; and
forming a base PC using the determined set of points.

6. The method of claim 1, wherein
selecting base PCs from the set of base PCs comprises:
determining a role assigned to the user; and
selecting the base PCs from the set of base PCs based on the role assigned to the user.

7. The method of claim 6, wherein
each base PC included in the set of base PCs is associated with a set of one or more roles,
the method further comprises storing information that identifies, for each base PC included in the set of base PCs, the roles with which the base PC is associated, and
the step of selecting the base PCs from the set of base PCs based on the role assigned to the user comprises selecting only the base PCs that are associated with the role assigned to the user.

8. The method of claim 1, wherein
the first base PC includes a first set of points,
the second base PC includes a second set of points, and
the first set of points and the second set of points are disjoint.

9. A non-transitory computer readable storage medium storing a computer program comprising instructions which when executed by processing circuitry of a network node causes the network node to perform the method of claim 1.

10. (canceled)

11. A point cloud management system (PCMS) for providing a point cloud (PC) to a user, the PCMS comprising:
memory; and
processing circuitry, wherein the PCMS is configured to perform a method comprising:
obtaining a set of images of a region of interest (ROI);
obtaining a set of base PCs associated with the ROI, wherein the set of base PCs comprises a first base PC and a second base PC;
receiving, from the user, a request for a PC related to the ROI;
after receiving the request, selecting base PCs from the set of base PCs;
generating a PC using the selected base PCs; and
providing the generated PC to the user, wherein
the base PCs selected from the set of base PCs includes the first base PC and the second base PC,
the first base PC includes points not included in the second base PC,
the second base PC includes points not included in the first base PC, and
the generated PC comprises: i) each point included in the first base PC and ii) each point included in the second base PC that is not also included in the first base PC.

12. The PCMS of claim 11, wherein
obtaining the set of base PCs comprises:
generating a primary PC; and
partitioning the primary PC into the set of base PCs.

13. The PCMS of claim 12, wherein
generating the primary PC comprises generating the primary PC from the obtained set of images.

14. The PCMS of claim 13, wherein
the obtained set of images comprises N images, where N>1, and
partitioning the primary PC into the set of base PCs comprises truncating the primary PC by performing a truncation process that comprises:
for each of the N images, obtaining two-dimensional, 2D, point information associated with the image, wherein the 2D point information associated with the image identifies a point on a common plane;
selecting a point cloud truncation method using the obtained 2D point information; and
implementing the selected a point cloud truncation method on the point cloud.

15. The PCMS of claim 12, wherein
partitioning the primary PC into the set of base PCs comprises:
identifying an object of interest, wherein a set of points in the primary PC is associated with the object of interest;
determining the set of points in the primary PC that are associated with the object of interest; and
forming a base PC using the determined set of points.

16. The PCMS of claim 11, wherein
selecting base PCs from the set of base PCs comprises:
determining a role assigned to the user; and
selecting the base PCs from the set of base PCs based on the role assigned to the user.

17. The PCMS of claim 16, wherein
each base PC included in the set of base PCs is associated with a set of one or more roles,
the method further comprises storing information that identifies, for each base PC included in the set of base PCs, the roles with which the base PC is associated, and
the step of selecting the base PCs from the set of base PCs based on the role assigned to the user comprises selecting only the base PCs that are associated with the role assigned to the user.

18. The PCMS of claim 11, wherein
the first base PC includes a first set of points,
the second base PC includes a second set of points, and
the first set of points and the second set of points are disjoint.
